(19) United States
(12) Patent Application Publication
(10) Pub. No.: US 2008/0005315 A1
(43) Pub. Date: Jan. 3, 2008

(54) Apparatus, system and method for stream-based data filtering

(76) Inventors: Po-Ching Lin, Taipei City (TW); Ying-Dar Lin, Hsinchu City (TW); Szu-Hao Chen, Hsinchu City (TW); Yuan-Cheng Lai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/476,577

(22) Filed: Jun. 29, 2006

(51) Int. Cl. G06F 15/173

(52) U.S. Cl. 709/224

(57) ABSTRACT

An apparatus, a system and a method for stream-based data filtering are disclosed. The apparatus is for filtering data transmitted from a sending end. The data is transmitted one by one by using a plurality of data segments. The data filtering apparatus includes a receiving module, a processing module and a transmission module. The receiving module is for receiving the data segments transmitted from the sending end. The processing module implements virus scanning for the data segments one by one. The transmission module then transmits the data segments which have passed through the virus scanning to a receiving end.

### FIELD OF THE INVENTION

The present invention relates to an apparatus, a system and a method for stream-based data filtering, and more particularly to the data filtering apparatus interleaves receiving, virus scanning, transmitting for every data segment.

### BACKGROUND OF THE INVENTION

Computer viruses may be easily spread and transmitted through the Internet. General speaking, implementing virus scanning on gateways or firewall systems has advantages with central management and early blocking malicious programs. Referring to FIG. 1, a block diagram illustrates a conventional antivirus apparatus. The antivirus apparatus 10 includes a receiving module 11, a storage unit 12, a processing module 13 and a transmission module 14. When a sending end 15 sends data 151 to a receiving end 16, the antivirus apparatus 10 would intercept data 151 through the receiving module 11. The data 151 are then store in the storage unit 12. After receiving and storing entire data 151, a virus scanning 131 is implemented through the processing module 13. If the data pass the virus scanning, the data are transmitted to the receiving end through the transmission module.

This way belongs to the storage-based antivirus system. Entire data are stored in advance and the virus scanning is then implemented. The system has disadvantages as follows:
1. The storage-based antivirus system needs larger memories and hard drive spaces. The scalability is worse.
2. The storage-based antivirus system must be installed in an apparatus with hard drives.
3. Storing data is time-consuming.
4. The conventional way may waste resources too fast and has loads for file system accesses while managing many computers.

To satisfy the demands for improving the storage antivirus system, the inventor of the present invention based on years of experience on related research and development invents an apparatus, a system and a method for stream-based data filtering to overcome the foregoing shortcomings.

### SUMMARY OF THE INVENTION

Accordingly, the object of the present invention is to provide an apparatus, a system and a method for stream-based data filtering. The data filtering apparatus implements receiving, virus scanning, sending for every data segment.

In accordance with the data filtering apparatus is for filtering data sent by a sending end. The data is transmitted one by one by using a plurality of data segments. The data filtering apparatus includes a receiving module, a processing module and a transmission module. The receiving module receives data segments transmitted from the sending end. The processing module implements a filtering action one by one for the data segments. The transmission module transmits the data segments which have passed through the filtering action to the receiving end. The filtering action is virus scanning.

The apparatus, the system and the method for stream-based data filtering have the following advantages:
1. The storage space required for entire system can be reduced to be a minimum. There is almost no need to use temporary files.
2. The file system access time can be reduced.
3. When there are compressed files, real-time decompression is implemented to interleave pre-processing, decompression and content filtering. The compression files do not need to be stored in advance and are real-time processed.
4. In the conventional way, the storage space is proportional to the file size and the number of connections. However, the storage space used in the present invention is proportional to the number of connections.

Other features and advantages of the present invention and variations thereof will become apparent from the following description, drawings, and claims.

### BRIEF DESCRIPTION OF THE DRAWINGS

FIG. 1 is a block diagram illustrating a conventional antivirus apparatus;

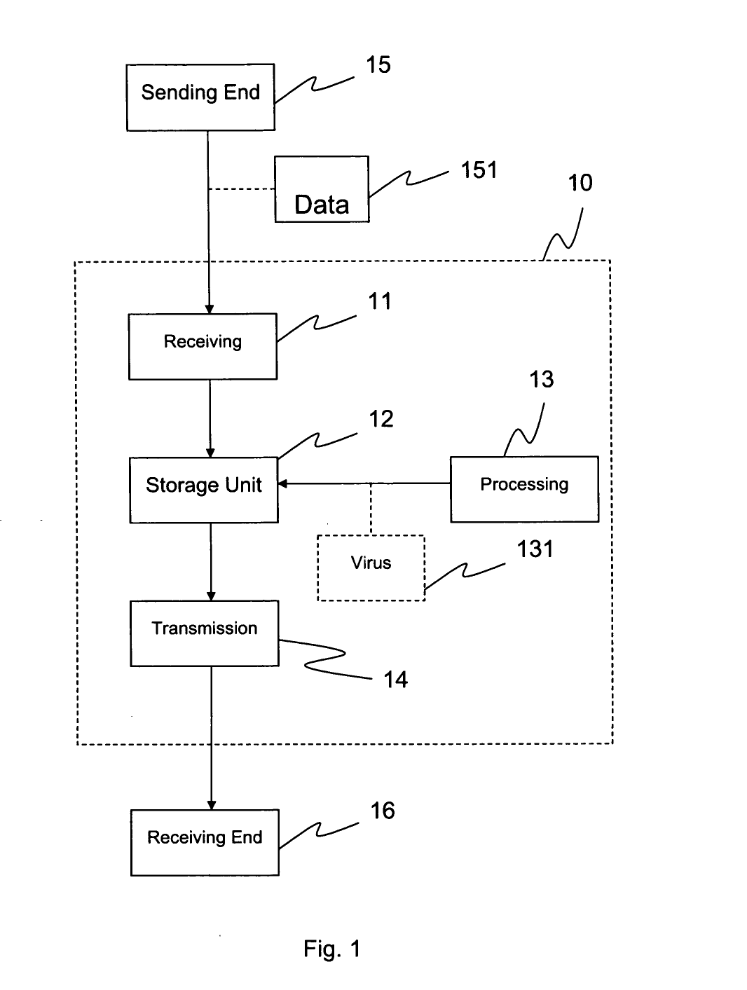

FIG. 2 is a block diagram illustrating a data filtering apparatus according to an embodiment of the present invention;

FIG. 3 is a block diagram illustrating a data filtering apparatus according to a preferred embodiment of the present invention;

FIG. 4 is a flowchart illustrating a method for data filtering according to an embodiment of the present invention;

FIG. 5 is a block diagram illustrating a data filtering system according to an embodiment of the present invention; and

FIG. 6 is a schematic diagram illustrating a data filtering system according to a preferred embodiment of the present invention.

### DETAILED DESCRIPTION OF THE PREFERRED EMBODIMENTS

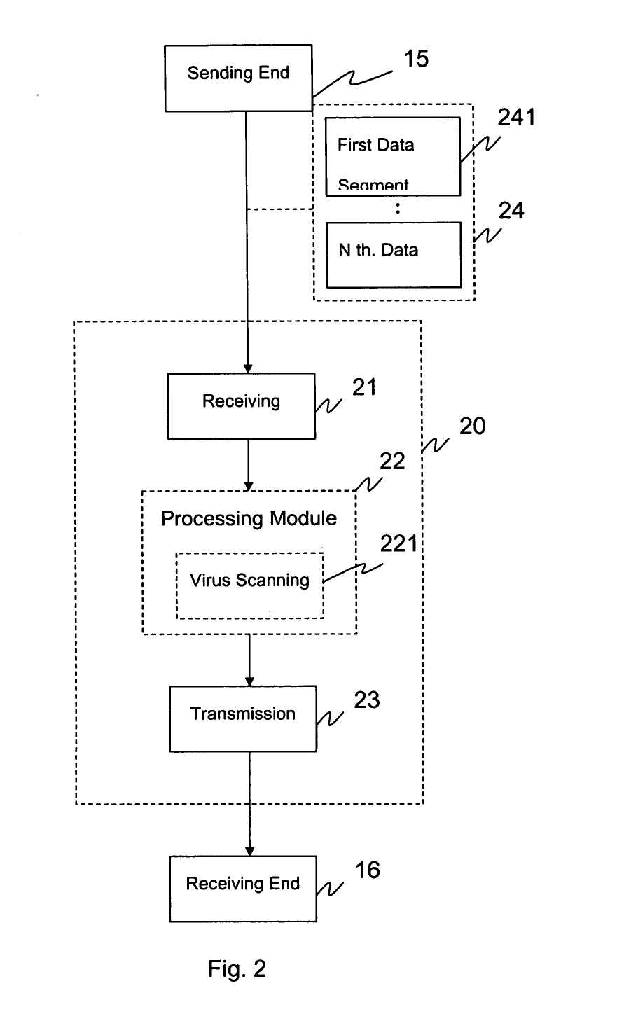

Referring to FIG. 2, a block diagram illustrates a data filtering apparatus according to an embodiment of the present invention. The data filtering apparatus 20 is for filtering data 24 transmitted by the sending end 15. The data 24 is transmitted one by one by using a plurality of data segments 241. The data filtering apparatus 20 includes a receiving module 21, a processing module 22 and a transmission module 23. The receiving module 21 is for receiving the data segments 241 transmitted from the sending end 15. The processing module 22 implements virus scanning 221 for the data segments 241. The transmission module 23 transmits the data segments 241 which have passed through the virus scanning 221 to the receiving end 16.

The data can be a file or an electronic mail. The processing module 22 implements a pre-processing before implementing the virus scanning 221. The pre-processing includes a Multipurpose Internet Mail Extension (MIME) parser, a MIME decoder or a real-time decompression. A buffer is disposed in the data filtering apparatus 20. The buffer is used in implementation process of the pre-processing. The space of the buffer is a constant. The constant does not follow the size of the data to be changed. The data filtering apparatus 20 further includes a determination module or a compression detection module. The determination module is for determining whether the data segments 241 cannot have viruses first. For instance, the data segments 241 can be merely pure text formats. If no virus is possible, the data segments 241 are directly transmitted to the receiving end 16 without implementing the virus scanning 221. The compression detection module is for determining whether the data segments 241 need to be implemented with the real-time decompression. The sending end 15 and the receiving end 16 are a computer.

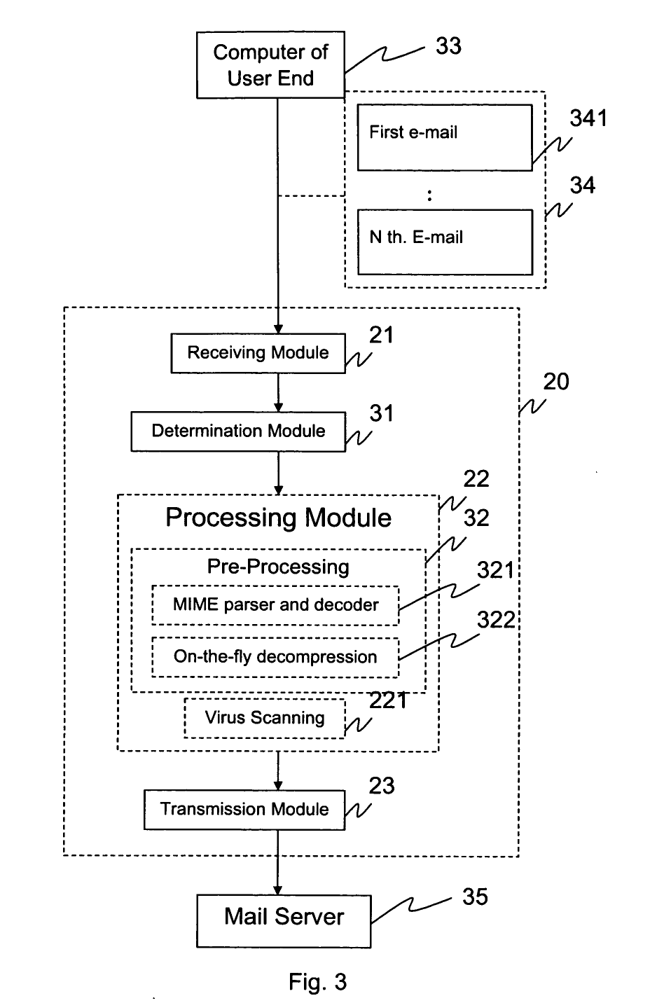

Referring to FIG. 3, a block diagram illustrates a data filtering apparatus according to a preferred embodiment of the present invention. The data filtering apparatus 20 includes the receiving module 21, a determination module 31, the processing module 22 and the transmission module 23. When a computer 33 of a user end transmits an electronic mail 34 to a mail server 35, the electronic mail 34 is transmitted by using a plurality of electronic mail segments 341. The data filtering apparatus 20 then intercepts the electronic mail segments 341 through the receiving module 21. The determination module 31 determines whether the electronic mail segments 341 cannot have viruses first. For example, the mail includes only pure English text. If no virus is possible, the electronic mail segments 341 are directly transmitted to the mail server 35 without implementing the virus scanning 221. If viruses are possible, the processing module 22 implements pre-processing 32 and the virus scanning 221. The pre-processing 32 includes the MIME parser and decoder 321, and on-the-fly decompression 322. Lastly, the transmission module 23 transmits the electronic mail segments 341 which have passed through the virus scanning 221 to the mail server 35.

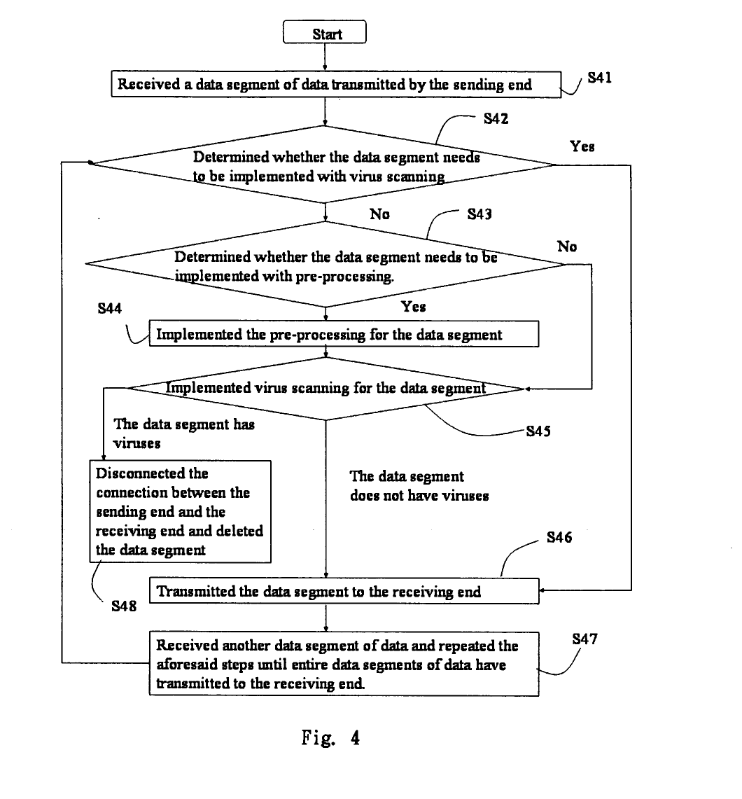

Referring to FIG. 4, a flowchart illustrates a method for filtering data according to an embodiment of the present invention. The method is applied to a data filtering apparatus. The data filtering apparatus is for filtering data transmitted by a sending end. The data is transmitted one by one by using a plurality of data segments. The steps of the method for filtering data are as follows:

Step S41: Received a data segment of data transmitted by the sending end

Step S42: Determined whether the data segment needs to be implemented with virus scanning. If it is impossible for the data segment to have viruses, step S46 is implemented. If it is possible for the data segment to have viruses, step S43 is implemented.

Step S43: Determined whether the data segment needs to be implemented with pre-processing. If the data segment needs to be implemented with the pre-processing, step S44 is implemented. If the data segment does need to be implemented with the pre-processing, step S45 is implemented.

Step S44: Implemented the pre-processing for the data segment.

Step S45: Implemented virus scanning for the data segment. If the data segment does not have viruses, step S46 is implemented.

Step S46: Transmitted the data segment to the receiving end.

Step S47: Received another data segment of data and repeated the aforesaid steps until entire data segments of data have transmitted to the receiving end.

The virus scanning described in step S45 is that if the data segment has viruses, step S48 is implemented.

Step S48: Disconnected the connection between the sending end and the receiving end and deleted the data segment.

The data is a file or an electronic mail. The pre-processing includes a MIME parser, a MIME decoder and a real-time decompression module. The sending end and the receiving end are a computer.

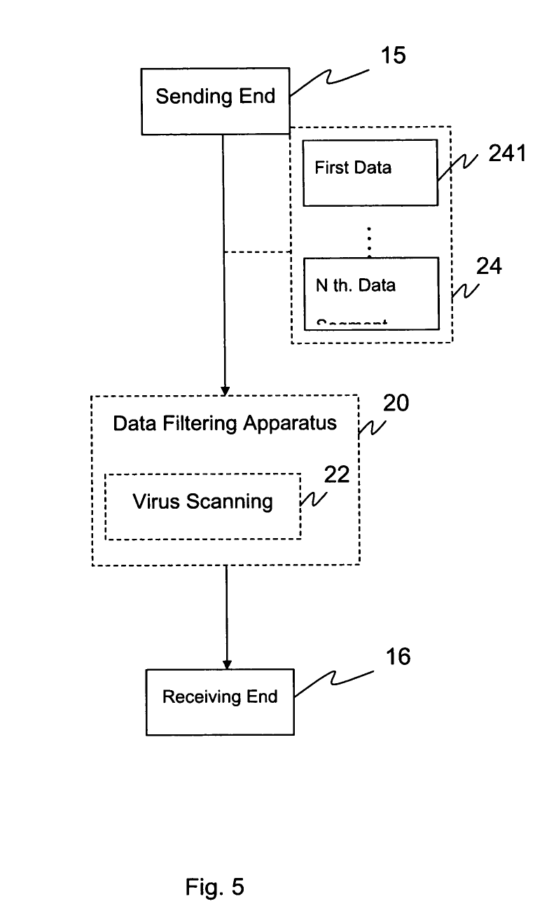

Referring to FIG. 5, a block diagram illustrates a data filtering system according to an embodiment of the present invention. The data filtering system includes the sending end 15, the receiving end 16 and the data filtering apparatus 20. The sending end 15 sends data 24. The data 24 is transmitted one by one by using the plurality of data segments 241. The data filtering apparatus 20 is disposed between the sending end 15 and the receiving end 16 and is for receiving the data segments 241 in order to implement the virus scanning 221 for the data segments 241 one by one. The data segments 241 which have passed through the virus scanning 221 are then transmitted to the receiving end 16.

The data 24 is a filter or an electronic mail. The data filtering apparatus 20 implements a pre-processing before implementing the virus scanning 221. The pre-processing includes a MIME parser, a MIME decoder and a real-time decompression module. The data filtering apparatus 20 further includes a determination module. The determination module is for determining whether the data segments 241 need to be implemented with the virus scanning in advance. For example, the data segments 241 are pure text formats. If it is impossible for the data segments to have viruses, the data segments 241 are directly transmitted to the receiving end 16 without implementing the virus scanning 221. The sending end 15 and the receiving end 16 are a computer.

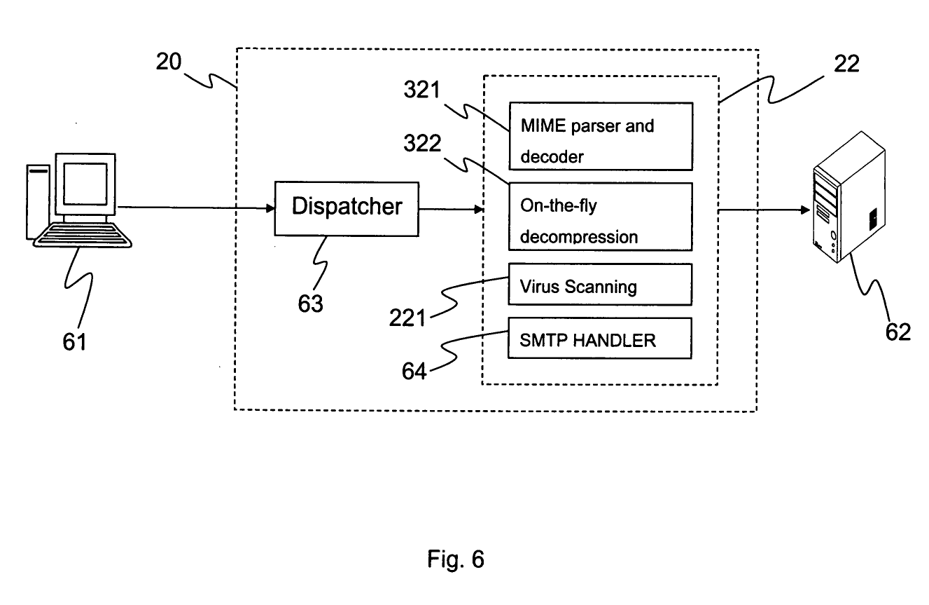

Referring to FIG. 6, a schematic diagram illustrates a data filtering system according to a preferred embodiment of the present invention. The data filtering system includes a computer 61, the data filtering apparatus 20 and a Simple Mail Transfer Protocol (SMTP) server 62. A dispatcher 63 intercepts packets from the computer of the user. The packets are guided to a SMTP hander 64. The SMTP handler 64 would make connection for the computer 61 of the user and the SMTP server 62 simultaneously and starts to transmit mails. The data segments of the mails may use streams to interleave the MIME parser and decoder 321, on-the-fly decompression 322 and the virus scanning 321. If no virus is possible, the mails are then transmitted to the SMTP server 62 otherwise the mails with viruses are blocked.

Although the features and advantages of the embodiments according to the preferred invention are disclosed, it is not limited to the embodiments described above, but encompasses any and all modifications and changes within the spirit and scope of the following claims.

What is claimed is:

1. A data filtering apparatus filtered data transmitted from a sending end, said data being transmitted one by one by using a plurality of data segments, comprising:
a receiving module received said data segments transmitted from said sending end;
a processing module implemented a filtering action for said data segments one by one; and
a transmission module transmitted said data segments to a receiving end, said data segments being passed through said filtering action.

2. The data filtering apparatus of claim 1, wherein said data is a file or an electronic mail.

3. The data filtering apparatus of claim 1, wherein said processing module performs pre-processing prior to said filter action.

4. The data filtering apparatus of claim 3, wherein said pre-processing includes a multipurpose internet mail extensions (MIME) parser, a MIME decoder and a real-time decompression module.

5. The data filtering apparatus of claim 3, wherein said data filtering apparatus further includes a buffer, and said buffer is utilized in implementation process of said pre-processing, and the space of said buffer is a constant, and said constant does not follow the size of said data to be changed.

6. The data filtering apparatus of claim 1, wherein said filtering action is virus scanning.

7. The data filtering apparatus of claim 6, wherein said data filtering apparatus further includes a determination module for determining whether said data segments need to be implemented with said virus scanning in advance, and if it is possible for said data segments to have viruses so that said data segments need to be implemented with said virus scanning, and if it is impossible for said data segments to have viruses so that said data segments are directly transmitted to said receiving end without implementing said virus scanning.

8. The data filtering apparatus of claim 4, wherein said data filtering apparatus further includes a compression detection module for determining whether said data segments need to be implemented with said real-time decompression.

9. The data filtering apparatus of claim 1, wherein said sending end and said receiving end are a computer.

10. A method for filtering data for use in a data filtering apparatus, said data filtering apparatus filtered data transmitted from a sending end, said data being transmitted one by one by using a plurality of data segments, comprising:
(a) receiving said data segment of said data transmitted by said sending end;
(b) determining whether said data segment cannot have viruses, wherein if no virus is possible for said data segment, implementing step (f) is implemented; otherwise, implementing step (c);
(c) determining whether said data segment needs to be implemented with pre-processing, if said data segment needs to be implemented with said pre-processing, implementing step (d), otherwise, implementing step (e);
(d) implementing said pre-processing for said data segment;
(e) implementing virus scanning for said data segment, if there is no virus in said data segment, implementing step (f);
(f) transmitting said data segments to a receiving end; and
(g) receiving another data segment of said data, and repeating step (b) to step (g) until all said data segments of said data being transmitted to said receiving end;
wherein in step (e) as said virus scanning, if there are viruses in said data segment, connections for said sending end and said receiving end are disconnected and said data segment is deleted.

11. The method for filtering data of claim 10, further comprising providing a file or an electronic mail to be said data.

12. The method for filtering data of claim 10, further comprising providing a multipurpose internet mail extensions (MIME) parser, a MIME decoder and a real-time decompression module to be said pre-processing.

13. The method for filtering data of claim 10, further comprising providing a buffer, wherein said buffer is utilized in implementation process of said pre-processing, and a space of said buffer is a constant, and said constant does not follow the size of said data to be changed.

14. The method for filtering data of claim 10, further comprising providing a computer to be said sending end and said receiving end.

15. A data filtering system, comprising:
a sending end sent data, said data being transmitted one by one by using a plurality of data segments;
a receiving end; and
a data filtering apparatus disposed between said sending end and said receiving end for receiving said data segments, a filtering action being implemented one by one for said data segments, said data segments being transmitted to said receiving end, said data segments being passed through said filtering action.

16. The data filtering system of claim 15, wherein said data is a file or an electronic mail.

17. The data filtering system of claim 15, wherein said data filtering apparatus implements pre-processing prior to said filter action.

18. The data filtering system of claim 17, wherein said pre-processing includes a multipurpose internet mail extensions (MIME) parser, a MIME decoder and a real-time decompression module.

19. The data filtering system of claim 17, wherein said data filtering system further includes a buffer, and said buffer is utilized in implementation process of said pre-processing, and a space of said buffer is a constant, and said constant does not follow the size of said data to be changed.

20. The data filtering system of claim 15, wherein said filter action is virus scanning.

21. The data filtering system of claim 20, wherein said data filtering system further includes a determination module for determining whether said data segments need to be implemented with said virus scanning in advance, and if it is possible for said data segments to have viruses so that said data segments need to be implemented with said virus scanning, and if no viruses is possible for said data segments so that said data segments are directly transmitted to said receiving end without implementing said virus scanning.

22. The data filtering system of claim 18, wherein said data filtering system further includes a compression detection module for determining whether said data segments need to be implemented with real-time decompression.

23. The data filtering system of claim 15, wherein said sending end and said receiving end are a computer.
